(19) United States
(12) Patent Application Publication
(10) Pub. No.: US 2009/0205585 A1
(43) Pub. Date: Aug. 20, 2009

(54) Pet leash assembly

(75) Inventors: Sharon A. La Herran, Campbell, CA (US); Chris J. Iles, Campbell, CA (US)

Correspondence Address: Sharon La Herran, 841 Robin Ln., Campbell, CA, 95008, US

(73) Assignee: Sharon A. La Herran, Campbell, CA (US)

(21) Appl. No.: 12/378,299

(22) Filed: Feb. 13, 2009

Related U.S. Application Data
(60) Provisional application No. 61/065,654, filed on Feb. 14, 2008.

(51) Int. Cl. A01K 27/00

(52) U.S. Cl. 119/795

(57) ABSTRACT

A pet leash assembly to carry filled bags of pet waste, with an attached clip mechanism or clip mechanisms. The apparatus allows for fast, lightweight attachment of filled bags of pet waste, for transportation on a leash, and easy detachment for proper disposal.

### 1. FIELD OF INVENTION

This invention relates generally to pet leash assembly to transport filled bags of pet waste, specifically required for transportation of animal waste on a leash for proper disposal.

### 2. STATUS OF PRIOR ART

4177909 December 1979 Haskell
March 1985 Jenkins
November 1994 Roe
August 1995 Lindsay
December 1997 Mitchell
March 1998 Conboy
April 1999 Furneaux
February 2000 Carey
July 2002 Starrett
May 2006 Rabello
5560321 October 1996 Hess

### Patents Pending:

20080179902 Jul. 31, 2008 Bradley Goldizen
20080216767 Sep. 11 2008 Xiano Long Wang
20080137994 Jun. 12, 2008 Urbina Borja
20080101731 May 1, 2008 Sylvia Carlson
200800121 Jan. 24, 2008 Tammy Mauro

### Foreign Patents:

255507
720914
2504354
2904289
672873

### BACK GROUND OF INVENTION

Today many States and cities have leash laws requiring pets must remain on a Leash in public, at all times. To keep our environment clean and healthy, there are also laws that require pet owners to clean up their pet waste, if the later is not followed, large fines are imposed.

The art of a solution has been sought after for years, regarding the retrieving and handling of pet waste. Up to date the most widely used way to retrieve pet waste is by hand, with the use of a plastic bag. There seems to be many solutions developed for carrying these empty plastic bags on a leash, however, very few have been developed to transport the filled plastic bags, once retrieved.

A portion of the pet waste that is actually being collected today in public, in plastic bags, which have no easy way to transport, are being thrown off to the side of the trail or street, thus turning into litter, or the pet owner is just not picking up the waste at all, thus creating an environmental hazard.

The alternatives for transporting pet waste on a leash today are made of small fabric containers, which are bulky. The problems with such containers are, 1, you are to wrestle a filled bag of waste into a small compartment, thus creating a situation, in which hands are in contact with the pet waste bag, 2, then you are to carry, the filled bag of waste on the leash along with the bulky container in which the pet waste is housed, and 3, a health hazard arises when you are to retrieve the pet waste bag out of the container to dispose of it.

Hence, all persons owning and walking a pet is in need of a solution to transport filled bags of waste easily, cleanly and effectively to proper disposal. The present invention provides a solution to transport pet waste on a leash, hands free, providing an easy to use, light weight solution that may very well encourage all pet owners who own it, to clean up pet waste and transport it for proper disposal.

### SUMMARY OF INVENTION

In view of the forgoing, the main objective of this invention is for the transportation of filled bags of pet waste, on an apparatus used to walk or restrain a animal. A Significant advantage of a pet leash in accordance with the invention is that it obviates the need to retrieve, transport and dispose of filled bags of waste properly.

More particularly an object of the invention is to provide the user with an all in one apparatus the above type, that can carry empty plastic bags, keys, cell phone, money that is adapted with an clip mechanism or mechanisms for light weight, non bulky, transportation of filled bags pet waste.

This invention is directed to satisfy the need for a simple solution to transport filled bags of pet waste efficiently, cleanly, hands free, on a pet leash to ensure proper disposal.

### BRIEF DESCRIPTION OF DRAWINGS

FIG. 1. A side view of a pet leash assembly embodying the invention

FIG. 2. A side view of pet leash assembly embodying the invention in a working state with waste bag attached,

FIG. 3. A top view of pet leash assembly

FIG. 4. A bottom view pet leash assembly

### DETAILED DESCRIPTION OF PREFERRED EMBODIMENTS

The invention is a pet leash assembly with the inclusion of 4 that can be used to carry animal waste while walking a animal.

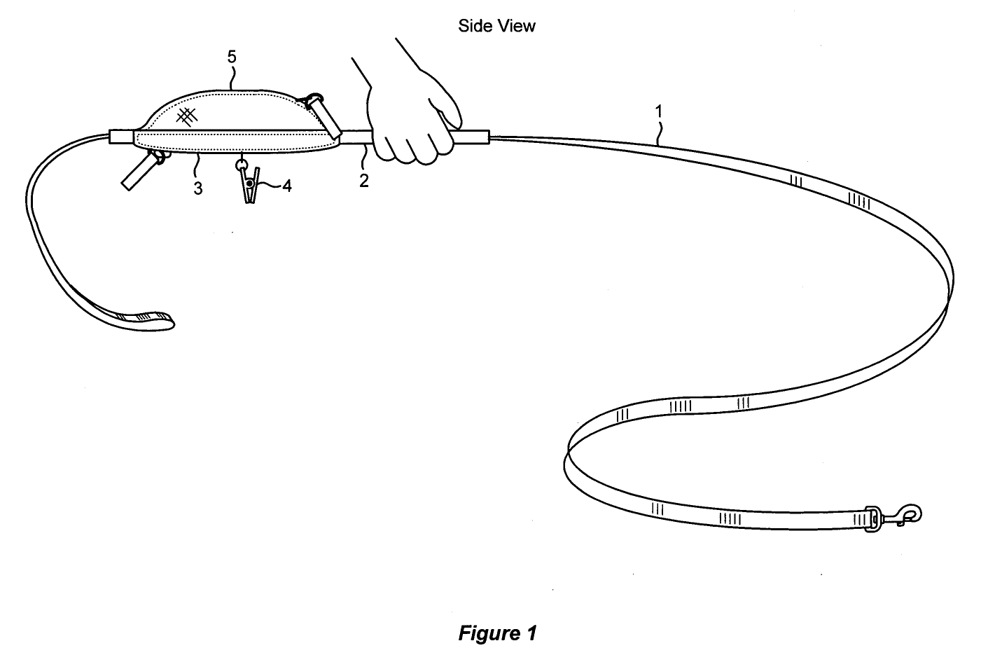

Referring now to FIG. 1:
an embodiment of the invention is 1 a pet leash: used to restrain or walk an animal, preferably of non fluid material preferably heavy duty as not to break or tear.
another embodiment of the invention is 4 preferably a small clip mechanism and or clip mechanisms, preferably opening in a jaws like fashion made preferably from metal in practice however, it may be constructed from plastic or any hard material used in the art, 4 is preferably 1 inch long and preferably ½ inch wide, and can be used to carry pet waste bags, hands free,
another embodiment of invention is 3, preferably a pocket positioned preferably on the underside of pet leash, 3 serves as a housing for 4 to keep 4 out of the way when not in use, 3 is preferably 6″ long and has preferably 6″ closure, preferably a zipper, however in the practice, velcro, snaps, rivets or any other means as to attach to apparatus, another embodiment of the invention 2, a housing fabricated from preferably non fluid material, housing preferably is preferably 12″ in length, said housing preferably encompasses said leash preferably lengthwise, forming support for holding, said housing is preferably sewn onto 1 however in practice, snaps glue staples Velcro, rivets or any other means may be used to attach preferred housing to pet leash,
another embodiment of invention is 5, preferably used as a storage compartment, preferably for carrying plastic bags and keys, cell phone and or other belongings, 5 is preferably fabricated out of non fluid material preferably strong canvas, nylon of any other materials used in the art. 5 preferably 6″ in length preferably located on the top of housing 2, storage compartment is preferably sewn onto housing 2, however in the art velcro, snaps rivets glue, could be used, 5 has preferably a 6 inch closure on the top, preferably a zipper, however in practice, velcro, snaps rivets, glue may be used, 5 is preferably a quarter moon shape, however in practice any other geometric shapes may be used,

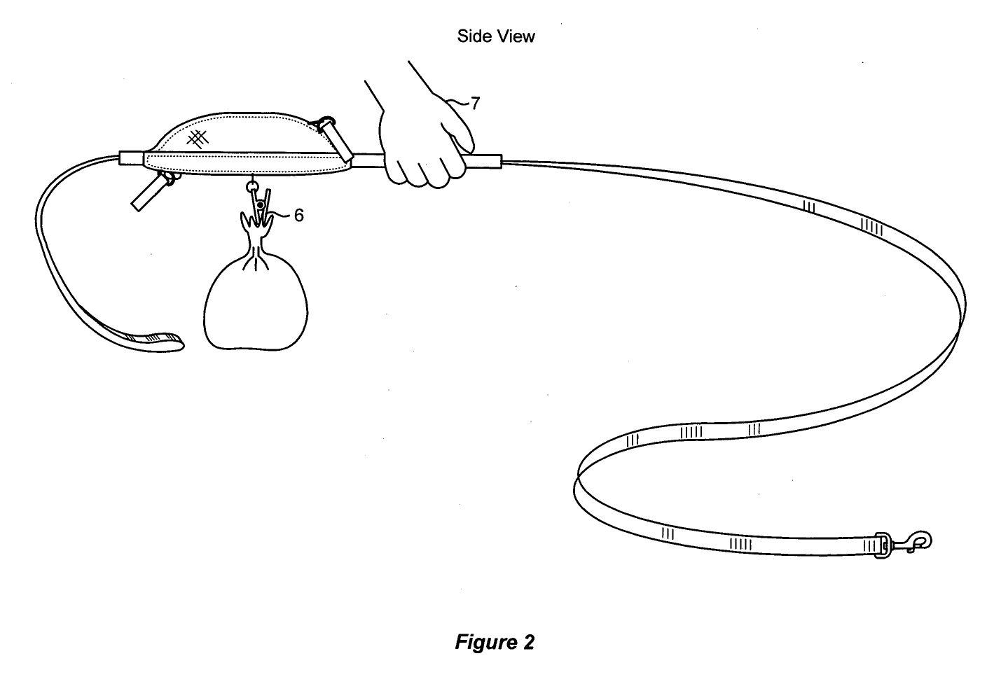

Referring now to FIG. 2:
6 showing clip mechanism use while transporting pet waste, 7 is showing hand position while in use,

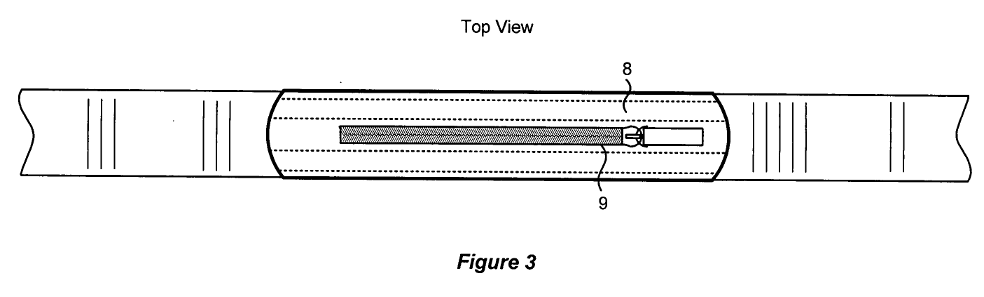

Referring now to FIG. 3:
a top view of invention, 8, is showing compartment 5 as shown in FIG. 1, compartment is preferably as wide as the size leash being manufactured and 9 showing preferably a zipper closure for easy access to 4 as shown in FIG. 1,

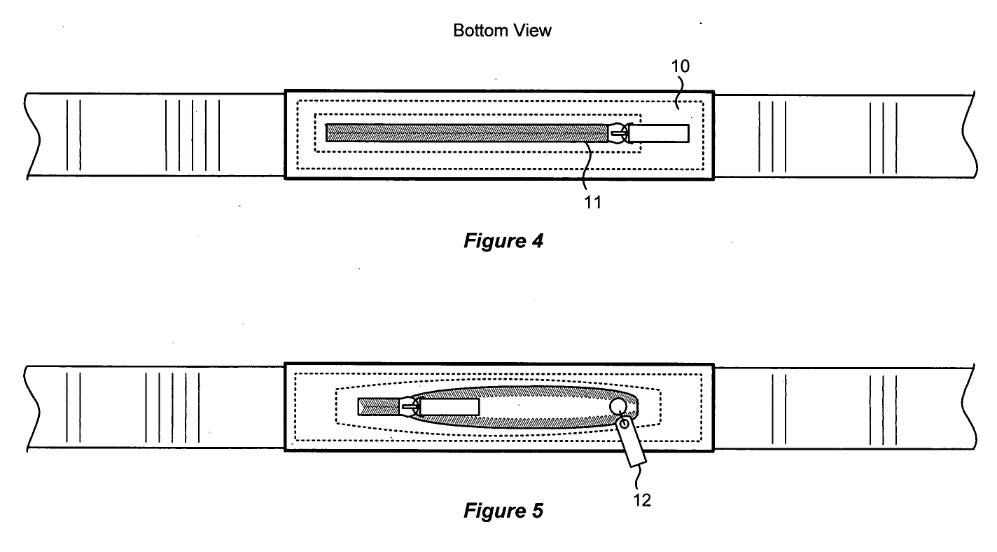

Referring to FIG. 4:
10 is a bottom view of compartment 3 as shown in FIG. 1, 11 showing preferably a zipper closure for easy access to 4 as shown in FIG. 1,

Referring now to FIG. 5; 12 is showing clip mechanism, preferably sewn into compartment 3 as shown in FIG. 1, This view shows how clip mechanism is accessed.

While there has been shown and described a preferred embodiment of the pet leash assembly it will be appreciated that many changes and modifications may be made therein without, however departing from the essential thereof.

What is claimed is:

1. A pet leash assembly for the transportation of pet waste comprising of:
a) a leash; an apparatus for walking or restraining an animal;
b) a clip mechanism or a plurality of clip mechanisms for, means of clipping pet waste bag to said apparatus;
c) a housing; comprising of non fluid material, encompasses said apparatus, to form said housing, said housing forms a supporting member for said clip mechanism, said housing, having a plurality of individual closures, houses a plurality of individual compartments for means of storing said clip mechanism or clip mechanisms plastic bags cell phone, keys or personal belongings;
wherein said leash, said clip mechanism, said housing, form a walking device for the transportation of pet waste.
